(19) United States
(12) Patent Application Publication
(10) Pub. No.: US 2006/0014551 A1
(43) Pub. Date: Jan. 19, 2006

(54) Apparatus and method for processing call in mobile communication system

(75) Inventors: Seung-Il Yoon, Seongnam-si (KR); Beom-Sik Bae, Suwon-si (KR); Jin-Soo Jeong, Anyang-si (KR); Jang-Hwan Kim, Yongin-si (KR); Chan-Bok Lee, Seoul (KR); Sung-Chul Hong, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/179,648

(22) Filed: Jul. 13, 2005

(30) Foreign Application Priority Data
Jul. 13, 2004 (KR) 2004-54548

(51) Int. Cl. H04Q 7/20

(52) U.S. Cl. 455/458; 455/456.1

(57) ABSTRACT

An apparatus and method for processing a call in a mobile communication system are provided. In the apparatus and method for processing a call in the mobile communication system, a base station sector at which a mobile station is located and a neighboring base station sector are designated as one call receiving zone when a mobile station transitions from a traffic state to a dormant state and paging is performed to a call receiving zone which is first designated when a call is received to the mobile station.

### CLAIM OF PRIORITY

This application claims the benefits under 35 U.S.C. §119(a) of an application entitled APPARATUS AND METHOD FOR PROCESSING CALL IN MOBILE COMMUNICATION SYSTEM filed in the Korean Intellectual Property Office on 13 Jul. 2004 and assigned Serial No. 2004-0054548, the entire contents of which are hereby incorporated by reference.

### BACKGROUND OF THE INVENTION

1. Field of the Invention

The present invention relates to call processing in a mobile communication system. More particularly, the present invention relates to an apparatus and method for processing a call which designates a base station sector at which a mobile station is located and a neighboring base station sector as one call receiving zone when the mobile station transitions from a traffic state to a dormant state and performs paging to a call receiving zone, which is first designated when the call is received by the mobile station.

2. Description of the Related Art

A radio channel used in a mobile communication system includes a pilot channel, a synchronous channel, a paging channel, a traffic channel, and so on.

The pilot channel always corresponds to a Walsh code “0”, and it is spread and modulated with a pseudo-noise (PN) code in the state in which it does not have any information regarding content, other signals or the like. Thus, the pilot channel is a short PN code itself and provides time information, phase reference information, and PN offset information for discriminating a base station.

The synchronous channel repetitively transmits certain information at a rate of 1.2 Kbps. The transmitted message (or sync channel message) has information corresponding to broadcasting other than information corresponding to a certain mobile station and provides the mobile station with information that is necessary for initial synchronization with the base station. The mobile station does not monitor the synchronous channel after receiving the initial synchronization information through the synchronous channel and transitions to a state in which it is capable of receiving the paging channel.

The base station transmits certain information to the mobile station over the paging channel at a rate of 4.8 Kbps or 9.6 Kbps. The message transmitted to the mobile station includes an overhead message through which all mobile stations receive system configuration-related information and a direct message, which only a certain mobile station receives in response information to a mobile station's call and request.

The traffic channel includes a forward traffic channel and a reverse traffic channel. The forward traffic channel delivers not only voice and data from the base station to the mobile station but also a signaling message using a null frame during a telephone call. The reverse traffic channel delivers not only voice and data from the mobile station to the base station but also a control signal during a telephone call. The data and control signal are simultaneously transmitted by a multiplex option function.

The base station performs a tracking zone reporting operation to accurately track the location of the mobile station.

The tracking zone reporting operation is specified in CDMA2000 1X Release D. For example, the base station repetitively transmits a tracking zone indicator which is designated to each sector in the base station's tracking zone. The mobile station registers the tracking zone indicator provided from an arbitrary base station in its tracking zone list and transmits a radio environment message (REM) to the base station to indicate a location change when it deviates from the base station's tracking zone.

However, the base station's tracking zone is a zone which is statically designated to the base station, and so it is difficult to dynamically designate a paging zone according to the characteristics of the mobile station or the mobile station's application program.

For example, if three sectors are designated to one tracking zone indicator, the mobile station which has the corresponding indicator list under the tracking zone reporting function designates just a paging zone for the three sectors.

Meanwhile, when a general call receiving procedure is performed by an exchange function of a mobile switching center (MSC) or a call receiving message is paged to all base stations within one subnet or exchange zone, the network experiences a heavy load.

A method for transmitting a general page message (GPM) to track the location of the mobile station and then paging to a base station to which the mobile station responds can reduce the network load, but it has a disadvantage in that the paging time is delayed. This also serves as a disadvantage when an invitation message should be transmitted to a mobile station of the other party in about 1 second in a push to talk (PTT) service, but is not due to the paging delay.

### SUMMARY OF THE INVENTION

It is, therefore, an objective of the present invention to provide an apparatus and method for processing a call which designates a base station sector in which a mobile station is located and a neighboring base station sector as one call receiving zone when the mobile station transitions from a traffic state to a dormant state and performs paging to a call receiving zone which is first designated when the call is received to the mobile station.

According to an aspect of the present invention, there is provided a mobile communication system comprising a node configured to designate a sector in which a mobile station is located and a neighboring sector as a virtual paging zone(VPZ), set VPZ information when the mobile station transitions from a traffic state to a dormant state and, send a page to a sector contained in the VPZ information according to a call connection request from a network; and a mobile station configured to perform a virtual paging operation according to the VPZ information is received from the node in the dormant state.

The VPZ information may comprise at least one of the VPZ lifetime information, the VPZ update cycle information, the VPZ identification information, and the sector information contained in the VPZ information.

The sector information contained in the VPZ information may include at least one of the network identification (NID) information, the system identification (SID) information of a base station system, the PN offset information of the base station system, reference pilot signal strength information for determining whether the mobile station is approaching the base station system or not, sector information for maintaining parameter information, which varies based on a comparison result of the pilot signal strength of the base station system measured by the mobile station and the reference pilot signal strength, and is used to determine whether to maintain the sector information, and the lifetime information of the sector information.

The virtual paging operation of the mobile station may comprise one of the following steps: a) deleting the VPZ information when the lifetime of the VPZ information expires; b) measuring the pilot signal strength of a corresponding sector to compare with the reference pilot signal strength, and varying the sector information maintaining parameter based on a comparison result for determining whether to maintain the sector information in the VPZ information of the corresponding sector, when the lifetime of the VPZ information does not expire; c) measuring the pilot signal strength of a corresponding sector to compare with the reference pilot signal strength, and determining whether to reset the lifetime of the sector information based on a comparison result when the lifetime of the VPZ information expires; and d) determining whether to change the VPZ information and determining whether to update an update cycle of the VPZ information based on the determination to change the VPZ information when the update cycle of the VPZ information expires.

The mobile communication system may further comprise a unit which stores the VPZ information received from at least one node and requests paging to a node contained in the VPZ information corresponding to a particular mobile station when there is a call connection request to a certain mobile station from a network.

The mobile station may comprise idle handoff information in a virtual handoff message and transmit to the node to which the mobile station wants to perform an idle handoff when the mobile station wants to perform an idle handoff to a sector covered by the node from among sectors that are not contained in the VPZ information.

The idle handoff information may comprise at least one of the information indicating whether the idle handoff information is contained in the virtual handoff message or not, the information indicating a source of the idle handoff information, and the sector information contained in the VPZ information.

According to another aspect of the present invention, there is provided a mobile communication system comprising an information processor for designating a sector in which a mobile station is located and a neighboring sector as a virtual paging zone (VPZ)and setting VPZ information when the mobile station transitions from a traffic state to a dormant state; an information provider for containing the VPZ information in a call release message and transmitting to the mobile station when a call to the mobile station is released; and a paging processor for performing paging to a sector contained in the VPZ information corresponding to the mobile station when there is a call connection request from a network.

The call release message may include at least one of the information indicating whether the VPZ information is contained in the call release message, the VPZ lifetime information, the VPZ update cycle information, the VPZ identification information, and the sector information contained in the VPZ information.

The information processor may produce a new VPZ information of mobile stations other than the mobile station using idle handoff information contained in a virtual handoff message received from the mobile stations and transmit to the mobile stations when the mobile stations perform an idle handoff to a sector covered by the base station system among sectors other than a sector contained in the VPZ information.

The idle handoff information contained in the virtual handoff message may comprise at least one of the information indicating whether the idle handoff information is contained in the virtual handoff message or not, the information indicating a source of the idle handoff information, and the sector information before the mobile stations perform an idle handoff.

The sector information contained in the VPZ information may include at least one of the network identification (NID) information, the system identification (SID) information of a base station system, the PN offset information of the base station system, the reference pilot signal strength information for determining whether the mobile station approaches to a base station system or not, the sector information maintaining parameter information, which varies based on a comparison result of pilot signal strength of the base station system measured by the mobile station and the reference pilot signal strength and is used to determine whether to maintain the sector information, and the lifetime information of the sector information.

The new VPZ information may include at least one of information indicating identification of the new VPZ information, information indicating lifetime of the new VPZ information, information indicating an update cycle of the new VPZ information, and sector information contained in the new VPZ information.

The sector information contained in the new VPZ information may include at least one of network identification (NID) information, system identification (SID) information of a base station system, PN offset information of the base station system, reference pilot signal strength information for determining whether the mobile station is approaching a base station system or not, sector information maintaining parameter information which varies based on a comparison result of the pilot signal strength of the base station system measured by the mobile station and the reference pilot signal strength, and is used to determine whether to maintain the sector information, lifetime information of the sector information, and information indicating whether to update the sector information.

According to still another aspect of the present invention, there is provided a mobile station in a mobile communication system comprising at least one mobile station and a node, the mobile station comprising a paging processor for performing a virtual paging operation when virtual paging zone (VPZ) information is received from the node after a call through the node is released; and a call processor for containing idle handoff information in a virtual handoff message and transmitting to a node to which the mobile station wants to perform an idle handoff when the mobile station wants to perform an idle handoff to a sector which are not contained in the VPZ information.

According to yet another aspect of the present invention, there is provided a method for processing a call in a mobile communication system, comprising the steps of designating a sector in which a mobile station is located and a neighboring sector as a virtual paging zone (VPZ)and setting VPZ information when the mobile station transitions from a traffic state to a dormant state; containing the VPZ information in a call release message and transmitting to the mobile station when a call with the mobile station is released; and performing paging to a sector contained in the VPZ information corresponding to the mobile station when there is a call connection request from a network.

The call processing method may further comprise the step of producing a new VPZ information of mobile stations other than the mobile station using idle handoff information contained in a virtual handoff message received from the mobile stations and transmit to the mobile stations the virtual handoff message when the mobile stations perform an idle handoff to a sector covered by the base station system among sectors other than a sector contained in the new VPZ information.

According to still yet another aspect of the present invention, there is provided a call processing method in a mobile station of a mobile communication system comprising at least one mobile station and a node, comprising the steps of performing a virtual paging operation when virtual paging zone (VPZ) information is received from the node after a call with the node is released; and containing idle handoff information in a virtual handoff message and transmitting the virtual handoff message to a node to which the mobile station wants to perform an idle handoff when the mobile station wants to perform an idle handoff to a sector which are not contained in the VPZ information.

### BRIEF DESCRIPTION OF THE DRAWINGS

A more complete appreciation of the invention, and many of the attendant advantages thereof, will be readily apparent as the embodiments of the present invention becomes better understood by reference to the following detailed description when considered in conjunction with the accompanying drawings in which like reference symbols indicate the same or similar components, wherein:

FIG. 1 is a schematic diagram showing the connection configuration of a mobile communication system according to an exemplary embodiment of the present invention;

FIG. 2 is a block diagram of a base station system according to an exemplary embodiment of the present invention;

FIG. 3 is a block diagram of a mobile station according to an exemplary embodiment of the present invention;

FIG. 4 is a diagram showing the procedure for collecting VPZ information when a mobile communication system is in a dormant state according to an exemplary embodiment of the present invention;

FIG. 5 is a diagram showing the paging processing procedure when a mobile communication system is in a dormant state according to an exemplary embodiment of the present invention;

FIG. 6 is a diagram showing the procedure for resetting the VPZ information depending on an idle handoff when a mobile communication system is in a dormant state according to an exemplary embodiment of the present invention;

FIG. 7 shows an overhead message according to an exemplary embodiment of the present invention;

FIGS. 8A and 8B show an extended release message (ERM) according to an exemplary embodiment of the present invention;

FIGS. 9A and 9B show a radio environment message (REM) according to an exemplary embodiment of the present invention; and

FIGS. 10A and 10B show a VPZ information update message according to an exemplary embodiment of the present invention.

It should be understood that like reference numbers refer to like features, structures and elements.

### DETAILED DESCRIPTION OF EXEMPLARY EMBODIMENTS

Hereinafter exemplary embodiments of a call processing apparatus and method in a mobile communication system of the present invention will be described in detail with reference to the accompanying drawings.

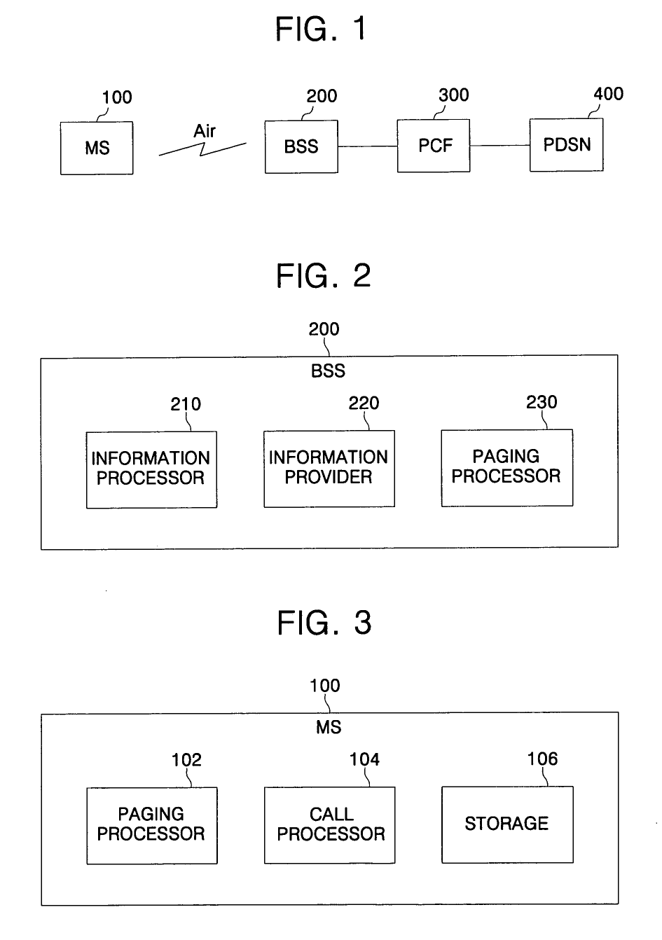

FIG. 1 is a schematic diagram showing the connection configuration of a mobile communication system according to an exemplary embodiment of the present invention.

As shown in FIG. 1, the mobile communication system comprises a mobile station (MS) 100, a base station system (BSS) 200, a packet control function (PCF) 300, and a packet data serving node (PDSN) 400. Here, the mobile communication system may be the CDMA2000 1x EV-DV system or the CDMA2000 1x EV-DO system. The embodiment of the present invention will be described below in detail with emphasis on the CDMA2000 1x EV-DV system, and the CDMA2000 1x EV-DO system will also be described below with respect to the differences in the CDMA2000 1x EV-DV system.

The MS 100 and the BSS 200 are preferably wirelessly linked, and the BSS 200, the PCF 300 and the PDSN 400 are preferably physically linked.

The BSS 200 designates a sector in which the MS 100 is located and a neighboring sector as one call receiving zone and sets them as virtual paging zone (VPZ) when the MS 100 transitions from a traffic state to a dormant state and tries paging to a sector contained in the VPZ information according to a call connection request to the MS 100.

That is, the BSS 200 designates a sector of an active set in which the MS 100 is located, a sector of a candidate set, and a sector of a neighbor set as the VPZ immediately before releasing a call.

The VPZ information preferably includes VPZ lifetime information, VPZ update cycle information, VPZ identification information, and sector information contained in the VPZ. The sector information contained in the VPZ includes network identification NID, system identification SID, reference pilot signal strength information KEEP_PILOT_STRENGTH, sector information maintaining parameter information NUMBER_OF_BELOW, and sector lifetime information, which will be explained later.

FIG. 2 is a block diagram of the BSS 200 according to an embodiment of the present invention. Referring to FIG. 2, the BSS 200 comprises an information processor 210, an information provider 220, and a paging processor 230.

The information processor 210 collects and designates a sector of an active set in which the MS 100 is located, a sector of a candidate set, and a sector of a neighbor set as the VPZ immediately before the MS 100 transitions from a traffic state to a dormant state and releases a call.

In the CDMA2000 1x EV-DO system, the information processor 210 designates a sector of an active set in which the MS 100 is located, a sector of a candidate set, and a sector of a neighbor set as the VPZ using a VPZ protocol immediately before the MS 100 transitions from a traffic state to a dormant state and releases a call.

The information provider 220 comprises the collected VPZ information in an extended release message (ERM) and provides it to the MS 100 when the MS 100 request a call release and provides the PCF 300 with the VPZ information. Here, the VPZ information contained in the ERM is shown in FIGS. 8A and 8B.

In the CDMA2000 1x EV-DO system, the information provider 220 comprises the VPZ information in a VPZ list message and provides it to the MS 100 over a control channel when the MS 100 requests a call release.

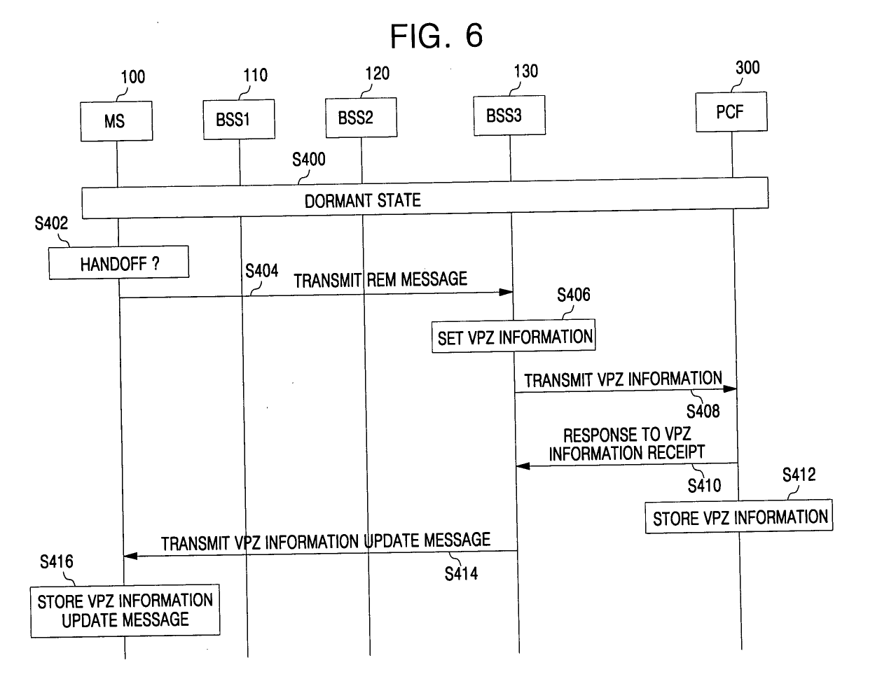

The information processor 210 updates the VPZ information of a certain MS 100 or sets the VPZ using information contained in the REM transmitted from the MS 100 when the certain MS 100 performs a handoff to one of the sectors covered by the BSS 200 other than sectors contained in the MS 100's VPZ, which will be explained later in more detail with reference to FIG. 6.

In the CDMA2000 1x EV-DO system, the information processor 210 updates the VPZ information of a certain MS 100 or sets the VPZ using information contained in a route update message transmitted from the MS 100 when the certain MS 100 performs a handoff to one of the sectors covered by the BSS 200 other than sectors contained in the MS 100's VPZ.

The paging processor 230 performs paging to a sector designated in the VPZ via the GPM or a directed extended channel assignment message (directed ECAM) for routing a call to the MS 100, which is in a dormant state when the PCF 300 receives a point to point protocol (PPP) frame to be transmitted to the MS 100 from the PDSN 400 or performs paging to a sector designated in the PVZ through a short data burst (SDB) when the received PPP frame is for the PTT service.

In the CDMA2000 1x EV-DO system, the paging processor 230 performs paging to a sector designated in the VPZ via a data over signaling (DOS) or a paging message for routing a call to the MS 100, which is in a dormant state, when the PCF 300 receives a point to point protocol (PPP) frame to be transmitted to the MS 100 from the PDSN 400. The DOS is specified in the CDMA2000 1x EV-DO Rev. A.

The MS 100 performs a virtual paging operation when it receives virtual paging information from the node in a dormant state, which will now be explained in more detail with reference to FIG. 3.

FIG. 3 is a block diagram of a mobile station (MS) according to an exemplary embodiment of the present invention.

As shown in FIG. 3, the MS 100 comprises a paging processor 102, a call processor 104, and a storage 106.

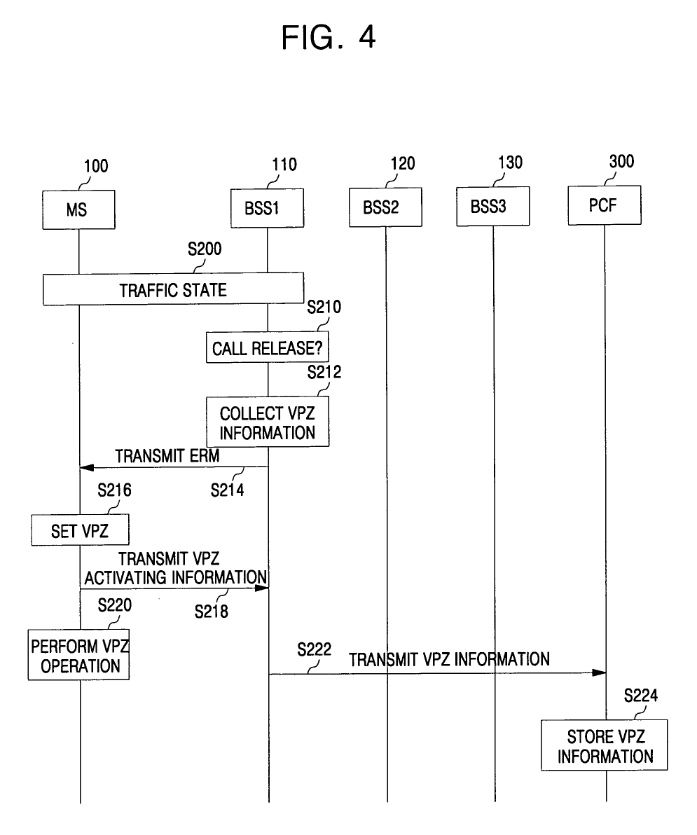

The paging processor 102 stores the VPZ information contained in the ERM transmitted from the BSS 200 in the storage 106, and then activates the VPZ function to perform the VPZ operation when the MS 100 transitions from a traffic state to a dormant state. The VPZ operation will be explained later in more detail with reference to FIG. 4.

In the CDMA2000 1x EV-DO, the paging processor 102 stores the VPZ information transmitted from the BSS 200 in the storage 106, and then activates the VPZ function to perform the VPZ operation when the MS 100 transitions from a traffic state to a dormant state.

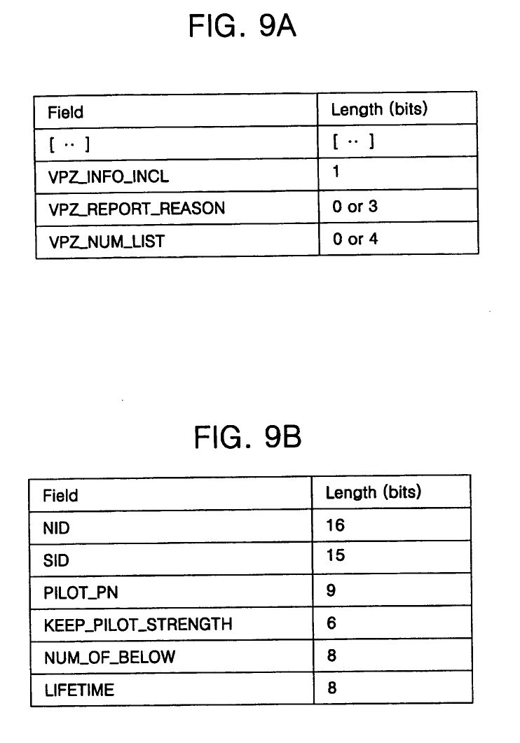

The call processor 104 provides the REM containing idle handoff information to a BSS to which the call processor 104 wants to perform an idle handoff when the MS performs an idle handoff to a sector that is not registered to the VPZ information. The REM containing the idle handoff information will be explained later in more detail with reference to FIGS. 9A and 9B.

In the CDMA2000 1x EV-DO, the call processor 104 preferably includes the idle handoff information in a VPZ production message or the route update message and transmits it to the BSS 200 which the call processor 104 wants to perform an idle handoff over the access channel when the MS performs an idle handoff to a sector, which is not registered to the VPZ information.

The PCF 300 (shown in FIG. 1) stores the VPZ information transmitted from the BSS 200 and collected immediately before releasing a call of the MS 100 in a database (not shown).

The PCF 300 stores the VPZ information for a certain MS when the certain MS other than the MS 100 performs an idle handoff to a region covered by the BSS 200 among regions which are not contained in the MS 100's VPZ. The VPZ information is collected by the BSS 200 in a database when the REM is received by the BSS 200.

In the CDMA2000 1x EV-DO system, the PCF 300 stores the VPZ information for a certain MS when the certain MS other than the MS 100 performs an idle handoff to a region covered by the BSS 200 among regions which are not contained in the MS 100's VPZ. The VPZ information is collected by the BSS 200 in a database when the REM is received by the BSS 200.

The PCF 300 retrieves the VPZ information of a corresponding MS from the database when a certain MS receives the PPP frame from the PDSN 400 (shown in FIG. 1) and request paging to the BSS corresponding to the retrieved MS's VPZ information.

FIG. 4 is a diagram showing the procedure for collecting VPZ information when a mobile communication system is in a dormant state according to an exemplary embodiment of the present invention.

As shown in FIG. 4, in a state that the MS 100 and the BSS1 110 maintain a traffic state (step S200), the BSS1 determines whether there is a call release request or not (step S210).

If there is a call release request, the BSS1 110 collects sectors of the BSS in which the MS 100 is located to form the VPZ information (S212), and includes the VPZ information in the ERM and provides it to the MS 100 (S214).

FIGS. 8A and 8B shows an exemplary ERM containing the VPZ provided to the MS 100 according to an embodiment of the present invention.

Referring to FIG. 8A, the ERM preferably includes, among the VPZ information, a VPZ information indication field VPZ_INFO_INCL, a VPZ identification field VPZ_ID, a VPZ lifetime field VPZ_LIFETIME, a VPZ information update cycle field VPZ_UPDATE_TIME, a sector information field VPZ—NUM—LIST contained in the VPZ information. Here, “[..]” denotes the existing fields of the ERM, which are specified in the CDMA2000 EV-DV release D layer 3, and thus a description of which is omitted.

The VPZ information indication field is a field for representing whether the VPZ information is contained in the ERM or not, and if the VPZ information indication field is set to “1”, it means that the VPZ information is contained in the ERM.

The VPZ identification field is a field for representing the identification of the VPZ, and if the VPZ information indication field is set to “0”, it is not contained in the ERM, and if the VPZ information indication field is set to a value other than “0”, it is contained in the ERM.

The VPZ lifetime field is a field for representing the lifetime of the VPZ, and if the VPZ information indication field is set to “0”, it is not contained in the ERM, and if the VPZ information indication field is set to a value other than “0”, lifetime of the VPZ information can be set within “60×VPZ lifetime field value” seconds.

The update cycle field of the VPZ information is a field for representing an update cycle of the VPZ information, and if the VPZ information indication field is set to “0”, it is not contained in the ERM, and if the VPZ information indication field is set to a value other than “0”, the update cycle of the VPZ information can be set within “60×VPZ lifetime field value” seconds.

The sector information field contained in the VPZ information is a field for representing information indicating a sector contained in the VPZ, and if the VPZ information indication field is set to “1”, the sector information of FIG. 8B can be contained in the VPZ.

Referring to FIG. 8B, the sector information preferably includes network identification NID, system identification SID, PILOT-PN field, reference pilot signal strength field KEEP_PILOT_STRENGTH, sector information maintaining parameter field NUM_OF_BELOW, and sector lifetime field LIFETIME. The NID is a field for representing number of the network to which the BSS belongs. The SID is a field for representing number of the BSS. The PILOT_PN field is a field for representing PN offset for discriminating the base stations according to a sector and can be set within 64 PN chips.

The reference pilot signal strength field is a field for representing information indicating reference pilot signal strength necessary for comparison with pilot signal strength of a certain sector measured by the MS, and the sector information maintaining parameter varies based on the comparison result of the pilot signal strength of a certain sector measured by the MS to the reference pilot signal strength.

The sector information maintaining field is a field containing a sector information maintaining parameter for determining whether the MS is located in a certain sector or not. Here, the sector information maintaining parameter is a parameter for determining whether the MS is located in a certain sector or not and varies based on the comparison result of the pilot signal strength of a certain sector measured by the MS to the reference pilot signal strength.

If the pilot signal strength of the certain sector measured by the MS is greater than the reference pilot signal strength, the sector information maintaining parameter is reduced by “1”, whereas if the pilot signal strength of the certain sector measured by the MS is smaller than the reference pilot signal strength, the sector information maintaining parameter is increased by “1”.

When the sector information maintaining parameter is increased by “1”, it means that the MS is getting farther away from the sector, whereas when the sector information maintaining parameter is reduced by “1”, it means that the MS is getting closer to the sector.

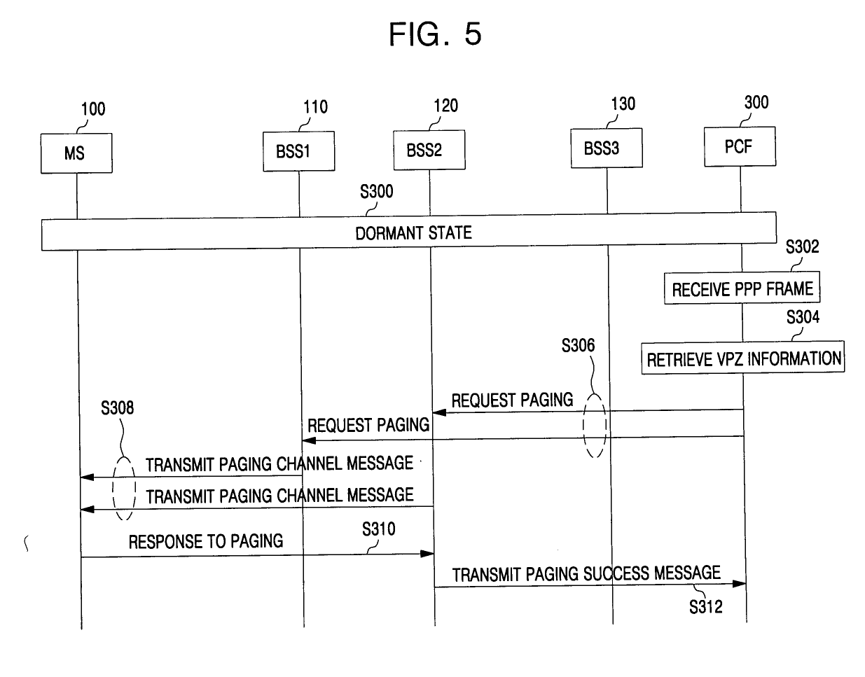

If the certain sector information maintaining parameter exceeds a VPZ information maintaining threshold count, that is, if the MS 100 deviates from the sector, the sector information is deleted. Here, the BSS 110 can insert the VPZ information maintaining threshold count in the overhead message for transmission, which will be explained in more detail with reference to FIG. 5.

The sector lifetime field is a field for representing the lifetime of the sector information and can be set in “60” second units.

Meanwhile, in the CDMA2000 1x EV-DO system, the BSS1 110 searches sectors of the BSS in which the MS 100 is located and collects the sectors to set the VPZ information, and preferably includes the VPZ information in the VPZ list message and transmits it to the MS 100 over the control channel.

With continued reference to FIG. 4, the MS 100 stores the VPZ information received from the BSS1 110 in a memory and activates or sets the VPZ function (step S216) and then informs the BSS1 110 of the fact that the VPZ function is activated (step S218).

Here, in order for the MS 100 to perform the VPZ function, the MS 100 needs to know that the BSS1 110 operates with regard to the VPZ information. For the sake of this, the BSS1 110 lets the MS 100 know that the VPZ information is operating in the BSS1 110 such that the BSS1 110 includes the VPZ information operation information in an extended system parameter message or an ANSI-41 system parameter message among the overhead messages and transmits it to the MS 100.

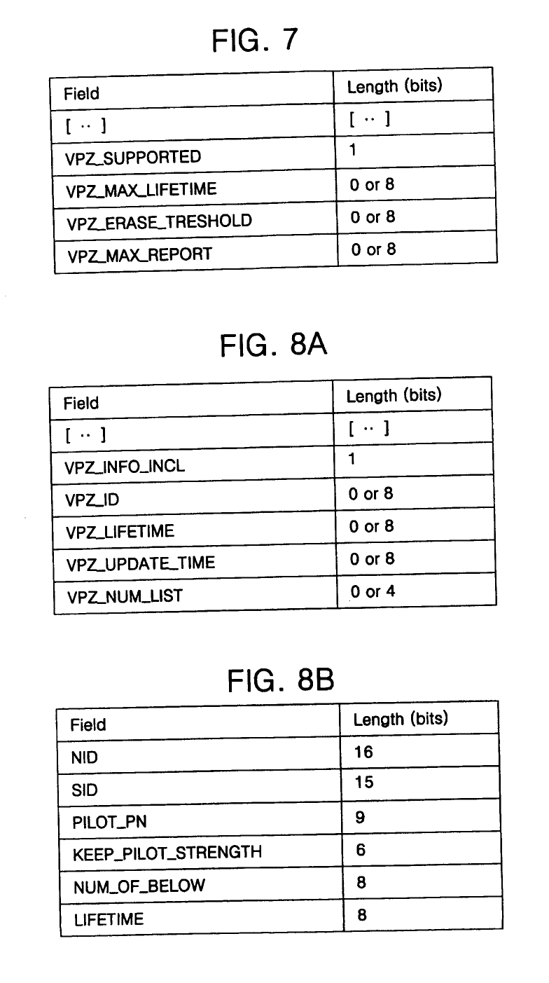

FIG. 7 shows an exemplary overhead message transmitted from the BSS1 110 to the MS 100 according to an embodiment of the present. Referring to FIG. 7, the VPZ information operation information contained in the overhead message preferably includes a VPZ information operation field VPZ_SUPPORTED, a VPZ information maximum lifetime field VPZ_MAX_LIFE, a VPZ information maintaining threshold count field VPZ_ERASE_TREHSHOLD, and a VPZ information report field VPZ_MAX_FIELD. Here, “[..]” denote the existing fields of the overhead message which are specified in the CDMA2000 EV-DV release D layer 3, and thus the description of which is omitted.

The VPZ information operation field is a field for representing whether the BSS operates the VPZ information or not, and if the VPZ information operation field is set to “1”, this means that the BSS operates the VPZ information. If the VPZ information operation field is set to “0”, it is not contained in the overhead message, and if the VPZ information operation field is set to a value other than “0”, it is contained in the overhead message.

The VPZ maximum lifetime field is a field containing the VPZ information maintaining threshold count information, which is a reference for determining whether to maintain a certain sector information.

The VPZ information report field is a field for representing the maximum count that the MS can contain the changed VPZ information in the REM to transmit it to the BSS, and if the VPZ information operation field is set to “0”, it is not contained in the overhead message, and if the VPZ information operation field is set to a value other than “0”, it is contained in the overhead message.

This can be used in determining whether to contain the VPZ information in the ERM which is transmitted for releasing a call with the MS 100 from the BSS1 110 by informing the BSS1 110 of the fact that the MS 100 performs the VPZ function through the origination message ORM for establishing traffic.

In the CDMA2000 1x EV-DO system, the MS 100 and the BSS1 110 determines whether to operate the VPZ information and whether the BSS1 110 makes the VPZ information or not when a call is released and sets the lifetime of the VPZ information, through VPZ protocol negotiation during session negotiation.

Thereafter, the MS 100 performs the VPZ operation (step S220). Here, the VPZ operation of the MS 100 is performed as one of the following operations.

a) The MS 100 deletes the VPZ information when the lifetime of the VPZ information expires.

b) The MS 100 measures the pilot signal strength of a corresponding sector and compares it to the reference pilot signal strength when the lifetime of the VPZ information does not expire. If the measured pilot signal strength is greater than the reference pilot signal strength, the sector information maintaining parameter is increased by “1”, whereas if the measured pilot signal strength is smaller than the reference pilot signal strength, the sector information maintaining parameter is decreased by “1”.

Then, the MS 100 compares the sector information maintaining parameter to the VPZ information maintaining threshold count. If the sector information maintaining parameter is greater than the VPZ information maintaining threshold count, the MS 100 determines as deviated from the corresponding sector zone and thus deletes the corresponding sector information from the VPZ information. On the other hand, if the sector information maintaining parameter is smaller than the VPZ information maintaining threshold count, the MS 100 determines as located in the corresponding sector zone and thus continuously maintains the corresponding sector information in the VPZ information.

c) The MS 100 measures the pilot signal strength of a corresponding sector and compares it to the reference pilot signal strength when lifetime of the sector registered to the VPZ information expires. If the measured pilot signal strength is greater than the reference pilot signal strength, the MS 100 sets the lifetime of the corresponding sector again to maintain the corresponding sector information. This is because the MS 100 is located in the corresponding sector zone.

Alternatively, if the measured pilot signal strength is smaller than the reference pilot signal strength, the MS 100 compares the sector information maintaining parameter to the VPZ information maintaining threshold count. If the sector information maintaining parameter is greater than the VPZ information maintaining threshold count, the MS 100 determines it has deviated from the corresponding sector zone and thus deletes the corresponding sector information from the VPZ information. However, if the sector information maintaining parameter is smaller than the VPZ information maintaining threshold count, the MS 100 determines it is located in the corresponding sector zone and thus continuously maintains the corresponding sector information in the VPZ information.

d) The MS 100 determines whether the VPZ information has changed or not when the VPZ information update cycle expires. The MS 100 updates only during the VPZ information update cycles when the VPZ information is not changed. However, when the VPZ information is changed, the MS 100 includes the changed VPZ information in the REM and transmits it to the BSS1 110.

e) The MS 100 inactivates the VPZ operation when it is difficult to maintain a dormant state and then deletes the VPZ information from the memory.

Meanwhile, the BSS1 110 provides the PCF 300 with the collected VPZ information when the MS activates the VPZ function (step S222), and the PCF 300 stores the VPZ information transmitted from the BSS1 110 in the database (step S224).

FIG. 5 is a diagram showing the paging processing procedure when a mobile communication system is in a dormant state according to an exemplary embodiment of the present invention.

Referring to FIG. 5, the MS 100 is in the dormant state (step S300). When the PPP frame is received from the PDSN 400 in a state that the mobile communication system maintains a dormant state (step S302), the PCF 300 retrieves the VPZ information of the MS to which the PPP frame is to be transmitted from the database (not shown) (step S304). Here, the MS to which the PPP frame is to be transmitted is referred to as MS 100, and the base station system corresponding to the VPZ information of the MS 100 is referred to as BSS1 110 and BSS2 120.

Then, the PCF 300 requests paging to the BSS1 110 and the BSS2 120 of the VPZ information of the MS 100 obtained by the retrieving result (step S306). In the CDMA2000 1x EV-DO system, the PCF 300 requests paging to the sector designated in the VPZ information through the DOS or the call receiving request message.

The BSS1 110 and the BSS2 120 performs paging to the MS 100 through the GPM or the directed ECAM by the paging request or through the SDB when the received PPP frame is for the PTT service (step S308). Here, the MS 100 is assumed to be located in the sector of the BSS2 120. Meanwhile, in the CDMA2000 1x EV-DO system, the BSS1 110 and the BSS2 120 performs paging to the MS 100 through the DOS or the page message.

The MS 100 responds to the BSS2 120 in response to the paging (step S310).

The BSS2 120 generates a paging success message in response to the paging response of the MS 100 and transmits it to the PCF 300 (step S312).

If the paging using the VPZ information is unsuccessful, the PCF 300 requests paging to all BSSs or requests paging to the mobile switching center (not shown).

Meanwhile, when the paging using the VPZ information is unsuccessful, the PCF 300 deletes the VPZ information. The PCF 300 deletes the corresponding information when the lifetime of the VPZ information expires but can utilize the VPZ information regardless of the lifetime of the VPZ information when the MS 100 restrictively moves or hardly moves without deleting the VPZ information.

FIG. 6 is a diagram showing the procedure for resetting VPZ information depending on an idle handoff when a mobile communication system is in a dormant state according to an exemplary embodiment of the present invention.

Referring to FIG. 6, when the MS 100 wants to perform a handoff to a BSS of a sector which is not registered to the VPZ information (step S420) in a state that the mobile communication system maintains a dormant state (step S400), the MS 100 preferably includes the idle handoff information in the REM and transmits to the BSS to which the MS 100 wants to handoff.

In the CDMA2000 1x EV-DO system, if the MS 100 wants to handoff to a BSS of a sector that is not registered to the VPZ information in a state that the mobile communication system maintains a dormant state, the MS 100 preferably includes the idle handoff information in the VPZ production message or the route update message and transmits it to the BSS to which the MS 100 wants to handoff over the access channel. Here, the VPZ production message preferably includes the sector information contained in the existing VPZ list and the information of a new sector to which the MS recently moved. The route update message preferably includes the VPZ information, which is produced before performing the idle handoff.

Here, the BSS to which the MS 100 performs the idle handoff is referred to as a BSS3 130, and the BSS1 110 and the BSS2 120 are the BSSs that are registered to the VPZ before the idle handoff. That is, the MS 100 transmits the REM or VPZ production message containing the idle handoff information to the BSS3 130, which is the BSS that the MS 100 wants to handoff (step S404).

Meanwhile, the exemplary REM containing the idle handoff information is shown in FIGS. 9A and 9B.

Referring to FIG. 9A, the REM preferably includes a VPZ information indication field VPZ_INFO_INCL, a VPZ information report reason field VPZ_REPORT_REASON, and a sector information field VPZ_NUM_LIST, which is contained in the VPZ information. Here, “[..]” of FIG. 9A denotes the existing fields of the ERM, which are specified in the CDMA2000 EV-DV release D layer 3 and thus a description of which is omitted.

The VPZ information indication field is a field for representing whether the REM includes the idle handoff information or not, and if the VPZ information indication field is set to “1”, this means that the REM includes the idle handoff information.

The VPZ information report reason field is a field for representing a report reason of the idle handoff information. If the VPZ information indication field is set to “0”, it is not contained in the REM, and if the VPZ information indication field is set to a value other than “0”, it is contained in the REM.

Meanwhile, if the VPZ information report reason field is set to “0”, this means that the idle handoff is performed to the sector which is not contained in the VPZ information list. If the VPZ information report reason field is set to “1”, this means that the VPZ information is still activated, the values “2” through “7” are reserved for other uses.

The sector information field VPZ_NUM_LIST, which is contained in the VPZ information, is a field for representing information indicating a sector contained in the idle handoff information, and if the VPZ information indication field is set to “1”, the sector information of FIG. 9B can be contained in the idle handoff information.

Referring to FIG. 9B, the sector information preferably includes network identification NID, system identification SID, PILOT-PN field, reference pilot signal strength field KEEP_PILOT_STRENGTH, sector information maintaining parameter field NUM_OF_BELOW, and sector lifetime field LIFETIME. The sector information of FIG. 9B is identical to that of FIG. 8B, and thus description on that is omitted.

When the REM is received from the MS 100, the BSS3 130 produces new VPZ information using the information contained in the REM. The BSS3 130 replaces information of the sector that the pilot signal strength is weakest among the newly produced VPZ information when the number of sectors registered to the existing VPZ information exceeds the threshold number (step S406). In the CDMA2000 1x EV-DO system, when the VPZ production message or the route update message is received from the MS 100, the BSS3 130 produces the new VPZ information in the case where a corresponding session supports the VPZ.

Then, the BSS3 130 transmits the newly collected VPZ information to the PCF 300 (step S408). Here, the systems contained in the newly collected VPZ information are the BSS1 110, the BSS2 120 and the BSS3 130.

When the newly collected VPZ information is received from the BSS3 130, the PCF 300 responds (step S410) and stores the VPZ information in the database (step S412).

When there is a response to the receipt of the newly collected VPZ information from the PCF 300, the BSS3 130 transmits the VPZ information update message containing the newly collected VPZ information to the MS 100 (step S414). The MS 100 stores the VPZ information update message in the memory (not shown) (step S416).

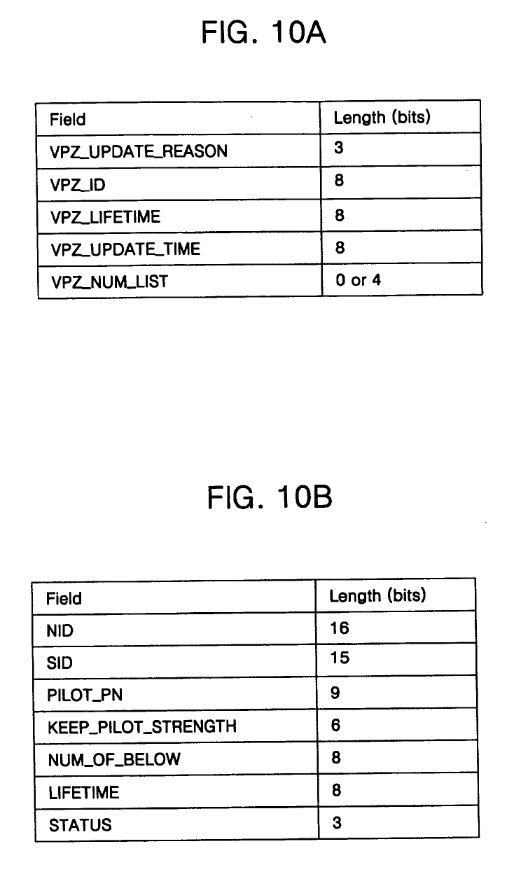

FIGS. 10A and 10B show an exemplary VPZ information update message according to an embodiment of the present invention.

Referring to FIG. 10A, the VPZ information update message preferably includes a VPZ information update report reason field VPZ_REPORT_REASON, a VPZ information update message identification field VPZ_ID, a VPZ information update message lifetime field VPZ_LIFETIME, a VPZ information update cycle field VPZ_UPDATE_TIME, and a sector information VPZ_NUM_LIST contained in the VPZ information update message.

If the VPZ information update report reason field is set to “0”, this means that the updated VPZ list is contained in the VPZ information update message, and if the VPZ information update report reason field is set to “1”, this means that VPZ function does not operate, and the values “2” through “7” are reserved for other uses.

The VPZ information update message identification field is a field for representing the identification of the updated VPZ information.

The VPZ information update message lifetime field is a field for representing lifetime of the updated VPZ information.

The VPZ information update cycle field is a field for representing am update cycle of the updated VPZ information.

When the sector information field VPZ_NUM_LIST contained in the VPZ information update message includes at least one of the sector information, each sector information includes network identification NID, system identification SID, PILOP-PN field, reference pilot signal strength field KEEP_PILOT_STRENGTH, sector information maintaining parameter field NUM_OF_BELOW, sector lifetime field LIFETIME, and update status field STATUS as shown in FIG. 10B.

The sector information of FIG. 10B is identical to those described above in FIGS. 8B and 9B, and thus a description of which is omitted. Merely, the update status field STATUS is a field for representing whether the VPZ information is updated or not. If the update status field is set “0”, this means that the VPZ information is not updated, and if the update status field is set “1”, this means that the VPZ information is updated, and the values “2” through “7” are reversed for other uses.

Meanwhile, the MS 100 generates a VPZ information update deny message and transmits it to the BSS3 130 when it cannot receive the VPZ information update message from the BSS3 130.

When the MS 100 wants to perform the VPZ function regardless of the receipt of the ERM, the MS 100 sets the VPZ information report reason field in the idle handoff information contained in the REM to “1” and sets the sector information field contained in the VPZ information to “0” and transmits them to the BSS3 130.

When the BSS3 130 receives the REM which preferably includes the VPZ information report reason field, which is set to “1”, and the sector information field contained in the VPZ information which is set to “0”, the BSS3 130 transmits the VPZ information update message to the MS 100.

When there is a call connection request to the MS 100, the BSS3 130 can perform a paging to a sector before the idle handoff and its own sector, if the MS 100 cannot receive the VPZ information update message due to the ping-pong phenomenon.

As described herein, the apparatus and method for processing a call in the mobile communication system according to an embodiment of the present invention can designate a base station sector in which a mobile station is located and a neighboring base station sector as one call receiving zone when a mobile station transitions from a traffic state to a dormant state and perform paging to a call receiving zone, which is first designated when a call is routed to a mobile station, thereby reducing a paging time to the MS in a dormant state, thereby increasing call receiving success to the corresponding MS, reducing the call receiving load of the mobile communication system, and processing a call receipt without the intervention of the MSC.

While the invention has been described in conjunction with various embodiments, they are illustrative only. Accordingly, many alternatives, modifications and variations will be apparent to persons skilled in the art in light of the foregoing detailed description. The foregoing description is intended to encompass all such alternatives, modifications and variations falling with the spirit and scope of the appended claims.

What is claimed is:

1. A mobile communication system, comprising:
a node configured to designate a sector in which a mobile station is located and a neighboring sector as a virtual paging zone (VPZ), set VPZ information when the mobile station transitions from a traffic state to a dormant state, and send pages to a sector contained in the VPZ information according to a call connection request from a network; and
a mobile station configured to perform a virtual paging operation according to the VPZ information is received from the node in the dormant state.

2. The system of claim 1, wherein the VPZ information includes at least one of VPZ information lifetime information, VPZ update cycle information, VPZ identification information, and sector information contained in the VPZ information.

3. The system of claim 2, wherein the sector information contained in the VPZ information includes at least one of network identification (NID) information, system identification (SID) information of a base station system, PN offset information of the base station system, reference pilot signal strength information for determining whether the mobile station is approaching the base station system or not, sector information maintaining parameter information which varies according to the comparison result of pilot signal strength of the base station system measured by the mobile station and the reference pilot signal strength and is used to determine whether to maintain the sector information, and lifetime information of the sector information.

4. The system of claim 1, wherein the virtual paging operation in the mobile station is one of the following:
a) deleting the VPZ information when the lifetime of the VPZ information expires;
b) measuring the pilot signal strength of a corresponding sector to compare with the reference pilot signal strength, and varying the sector information maintaining parameter based on the comparison result to determine whether to maintain the sector information in the VPZ information of the corresponding sector, when the lifetime of the sector information contained in the VPZ information does not expire;
c) measuring the pilot signal strength of a corresponding sector to compare with the reference pilot signal strength, and determining whether to reset the lifetime of the sector information based on the comparison result when the lifetime of the sector information contained in the VPZ information expires; and
d) determining whether to change the VPZ information and determining whether to update an update cycle of the VPZ information according to the determination result when the update cycle of the VPZ information expires.

5. The system of claim 1, further comprising a unit which stores the VPZ information received from at least one node and requests paging to a node contained in the VPZ information corresponding to a corresponding mobile station when there is a call connection request to a certain mobile station from a network.

6. The system of claim 1, wherein the mobile station includes idle handoff information in a virtual handoff message and transmits to the node to which the mobile station wants to handoff when the mobile station wants to perform an idle handoff to a sector covered by the node among sectors which are not contained in the VPZ information.

7. The system of claim 6, wherein the idle handoff information includes at least one of information indicating whether the idle handoff information is contained in the virtual handoff message or not, information indicating a source of the idle handoff information, and sector information contained in the VPZ information.

8. A mobile communication system, comprising:
an information processor for designating a sector in which a mobile station is located and a neighboring sector as virtual paging zone (VPZ) and setting VPZ information when the mobile station transitions from a traffic state to a dormant state;
an information provider for containing the VPZ information in a call release message and transmitting to the mobile station when a call to the mobile station is released; and
a paging processor for performing paging to a sector contained in the VPZ information corresponding to the mobile station when there is a call connection request from a network.

9. The system of claim 8, wherein the call release message includes at least one of information indicating whether the VPZ information is contained in the call release message, VPZ lifetime information, VPZ update cycle information, VPZ identification information, and sector information contained in the VPZ information.

10. The system of claim 9, wherein the sector information contained in the VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on the comparison result of pilot signal strength of the base station system measured by the mobile station and the reference pilot signal strength, and is used to determine whether to maintain the sector information, and lifetime information of the sector information.

11. The system of claim 8, wherein the information processor produces a new VPZ information of mobile stations other than the mobile station using idle handoff information contained in a virtual handoff message received from the mobile stations and transmits to the mobile stations when the mobile stations perform an idle handoff to a sector covered by the base station system among sectors other than a sector contained in the VPZ information.

12. The system of claim 11, wherein the idle handoff information contained in the virtual handoff message includes at least one of information indicating whether the idle handoff information is contained in the virtual handoff message or not, information indicating a source of the idle handoff information, and sector information before the mobile stations perform an idle handoff.

13. The system of claim 12, wherein the sector information contained in the VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength, and is used to determine whether to maintain the sector information, and lifetime information of the sector information.

14. The system of claim 11, wherein the new VPZ information includes at least one of information indicating identification of the new VPZ information, information indicating lifetime of the new VPZ information, information indicating an update cycle of the new VPZ information, and sector information contained in the new VPZ information.

15. The system of claim 14, wherein the sector information contained in the new VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, lifetime information of the sector information, and information indicating whether to update the sector information.

16. A mobile station in a mobile communication system comprising at least one mobile station and a node, comprising:
a paging processor for performing a virtual paging operation when virtual paging zone (VPZ) information is received from the node after a call with the node is released; and
a call processor for containing idle handoff information in a virtual handoff message and transmitting to a node to which the mobile station wants to perform an idle handoff when the mobile station wants to perform an idle handoff to a sector which are not contained in the VPZ information.

17. The mobile station of claim 16, wherein the VPZ information includes at least one of VPZ lifetime information, VPZ update cycle information, VPZ identification information, and sector information contained in the VPZ information.

18. The mobile station of claim 17, wherein the sector information contained in the VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, and lifetime information of the sector information.

19. The mobile station of claim 16, wherein the virtual paging operation of the mobile station is one of the following:
a) deleting the VPZ information when the lifetime of the VPZ information expires;
b) measuring the pilot signal strength of a corresponding sector to compare with the reference pilot signal strength, and varying the sector information maintaining parameter based on the comparison result to determine whether to maintain the sector information in the VPZ information of the corresponding sector, when the lifetime of the sector information contained in the VPZ information does not expire;
c) measuring the pilot signal strength of a corresponding sector to compare with the reference pilot signal strength, and determining whether to reset the lifetime of the sector information based on the comparison result when the lifetime of the sector information contained in the VPZ information expires; and
d) determining whether to change the VPZ information and determining whether to update an update cycle of the VPZ information according to the determination result when the update cycle of the VPZ information expires.

20. The mobile station of claim 16, wherein the idle handoff information includes at least one of information indicating whether the idle handoff information is contained in the virtual handoff message or not, information indicating a source of the idle handoff information, and sector information contained in the VPZ information.

21. A method for processing a call in a mobile communication system, the method comprising the steps of:
designating a sector in which a mobile station is located and a neighboring sector as a virtual paging zone (VPZ) and setting VPZ information when the mobile station transitions from a traffic state to a dormant state;
containing the VPZ information in a call release message and transmitting to the mobile station when a call with the mobile station is released; and
performing paging to a sector contained in the VPZ information corresponding to the mobile station when there is a call connection request from a network.

22. The method of claim 21, wherein the call release message includes at least one of information indicating whether the VPZ information is contained in the call release message, VPZ lifetime information, VPZ update cycle information, VPZ identification information, and sector information contained in the VPZ information.

23. The method of claim 22, wherein the sector information contained in the VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, and lifetime information of the sector information.

24. The method of claim 21, further comprising the step of producing a new VPZ information of mobile stations other than the mobile station using idle handoff information contained in a virtual handoff message received from the mobile stations and transmitting to the mobile stations when the mobile stations perform an idle handoff to a sector covered by the base station system among sectors other than a sector contained in the VPZ information.

25. The method of claim 24, wherein the idle handoff information contained in the virtual handoff message includes at least one of information indicating whether the idle handoff information is contained in the virtual handoff message or not, information indicating a source of the idle handoff information, and sector information before the mobile stations perform an idle handoff.

26. The method of claim 25, wherein the sector information contained in the VPZ information includes at least one of network identification (NID) information, system identification (SID) information of a base station system, PN offset information of the base station system, reference pilot signal strength for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, and lifetime information of the sector information.

27. The method of claim 24, wherein the new VPZ information includes at least one of information indicating identification of the new VPZ information, information indicating lifetime of the new VPZ information, information indicating an update cycle of the new VPZ information, and sector information contained in the new VPZ information.

28. The method of claim 27, wherein the sector information contained in the new VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, lifetime information of the sector information, and information indicating whether to update the sector information.

29. A method for processing a call in a mobile station of a mobile communication system including at least one mobile station and a node, the method comprising the steps of:
performing a virtual paging operation when virtual paging zone (VPZ) information is received from the node after a call with the node is released; and
containing idle handoff information in a virtual handoff message and transmitting to a node to which the mobile station wants to perform an idle handoff when the mobile station wants to perform an idle handoff to a sector which are not contained in the VPZ information.

30. The method of claim 29, wherein the VPZ information includes at least one of VPZ lifetime information, VPZ update cycle information, VPZ identification information, and sector information contained in the VPZ information.

31. The method of claim 30, wherein the sector information contained in the VPZ information includes at least one of network identification (NID) information, system identification (SID) information of a base station system, PN offset information of the base station system, reference pilot signal strength information for determining whether the mobile station approaches to the base station system or not, sector information maintaining parameter information which varies based on a comparison result of pilot signal strength of the base station system measured by the mobile station and the reference pilot signal strength and is used to determine whether to maintain the sector information, and lifetime information of the sector information.

32. The method of claim 29, wherein the virtual paging operation of the mobile station is one of the followings:
a) deleting the VPZ information when the lifetime of the VPZ information expires;
b) measuring the pilot signal strength of a corresponding sector to compare with the reference pilot signal strength, and varying the sector information maintaining parameter based on the comparison result to determine whether to maintain the sector information in the VPZ information of the corresponding sector, when the lifetime of the sector information contained in the VPZ information does not expire;
c) measuring the pilot signal strength of a corresponding sector to compare with the reference pilot signal strength, and determining whether to reset the lifetime of the sector information based on the comparison result when the lifetime of the sector information contained in the VPZ information expires; and
d) determining whether to change the VPZ information and determining whether to update an update cycle VPZ information according to the determination result when the VPZ information update cycle expires.

33. The method of claim 29, wherein the idle handoff information includes at least one of information indicating whether the idle handoff information is contained in the virtual handoff message or not, information indicating a source of the idle handoff information, and sector information contained in the VPZ information.
